(19) United States
(12) Patent Application Publication
(10) Pub. No.: US 2021/0325731 A1
(43) Pub. Date: Oct. 21, 2021

(54) BACKLIGHT MODULE, DRIVING METHOD THEREOF AND DISPLAY APPARATUS

(71) Applicants: Beijing BOE Optoelectronics Technology Co., Ltd., Beijing (CN); BOE TECHNOLOGY GROUP CO., LTD., Beijing (CN)

(72) Inventors: Zhonghua LI, Beijing (CN); Shipeng WANG, Beijing (CN); Shaofei GUO, Beijing (CN); Yiping RUAN, Beijing (CN); Dongjia HAO, Beijing (CN)

(21) Appl. No.: 17/197,110

(22) Filed: Mar. 10, 2021

(30) Foreign Application Priority Data
Apr. 20, 2020 (CN) 202010311259.3

(51) Int. Cl. G02F 1/13357; G06F 3/147; G02F 1/1335; H05B 47/155; H05B 45/10

(52) U.S. Cl. CPC G02F 1/133605; G06F 3/147; G02F 1/133603; H05B 45/10; G02F 1/133612; H05B 47/155; G02F 1/133606

(57) ABSTRACT

One or more embodiments of this specification provide a backlight module, a driving method thereof, and a display apparatus. The backlight module includes a back plate provided with a plurality of recessed portions and raised portions alternately distributed in sequence; a reflective layer provided on an inner wall of the recessed portion; a first light source provided at a bottom of the recessed portion; and a second light source provided on the raised portion.

### CROSS-REFERENCE TO RELATED APPLICATION

This application claims the benefit of and priority to Chinese Patent Application No. 202010311259.3, filed on Apr. 20, 2020, the contents of which being incorporated by reference in their entirety herein.

### TECHNICAL FIELD

One or more embodiments herein relate to the field of display technology and, in particular to a backlight module, a driving method thereof, and a display apparatus.

### BACKGROUND

With the development of display technology, more and more people carry mobile products to read, study, or work in public places, and the demand for anti-peep display apparatuses is also increasing.

However, in the related art, the anti-peep display apparatus has various problems, such as large thickness, insufficient brightness, and unsatisfactory anti-peep effects at large viewing angles.

### SUMMARY

In view of this, the purpose of one or more embodiments of this specification is to provide a backlight module, a driving method thereof and a display apparatus, so as to solve the problems of low brightness and complicated process of the anti-peep display in the prior art.

Based on the foregoing objectives, one or more embodiments of this specification provide a backlight module, including:

a back plate, provided with a plurality of recessed portions and raised portions alternately distributed in sequence;

a reflective layer, provided on an inner wall of the recessed portion;

a first light source, provided at a bottom of the recessed portion; and

a second light source, provided on the raised portion.

Optionally, each of the recessed portions is a groove having an extension direction perpendicular to a direction along which any recessed portion faces toward a raised portion adjacent to the recessed portion, and the grooves are equidistantly distributed along the direction that any recessed portion faces toward a raised portion adjacent to the recessed portion.

Optionally, each of the recessed portions has a cup-shaped structure, and a plurality of the recessed portions are arranged in an array on the back plate.

Optionally, the bottom of the recessed portion is smaller than an opening of the recessed portion.

Optionally, the inner wall of the recessed portion includes one of a flat surface, a curved surface and a polygonal surface.

Optionally, the backlight module further includes:

acquiring a light source distance A between a center of the first light source and an opening of the recessed portion, a diameter B at the opening of the recessed portion, an angle C of the strongest light, a maximum reflected light angle D, and an irradiation distance L;

determining an overall dimension of the recessed portion and the maximum reflected light angle D based on the light source distance A and the diameter B at the opening;

determining a brightness distribution of the first light source based on the angle C of the strongest light, the maximum reflected light angle D and the irradiation distance L; and

determining a reflection curve based on the light source distance A, the diameter B at the opening, the angle C of the strongest light and the maximum reflected light angle D, and determining a shape of the inner wall of the recessed portion based on the reflection curve.

Optionally, a material of the reflective layer includes one of a specular reflective material, a diffuse reflective material, and a reflective material with a surface microstructure.

Optionally, each of the first light source and the second light source includes an LED light bar or an LED chip.

Optionally, a plurality of the first light sources are distributed in an array on the back plate; and a plurality of the second light sources are distributed in an array on the back plate.

Optionally, the first light source is further configured to emit light in a sharing state.

Optionally, the backlight module further includes:

a first circuit board, provided between the first light source and the recessed portion to realize a connection between the first light source and the driving circuit;

a second circuit board, provided between the second light source and the raised portion to realize a connection between the second light source and the driving circuit.

Optionally, the backlight module further includes:

a diffusion film, provided on a side of the second light source away from the back plate.

One or more embodiments of this specification further provide a driving method of a backlight module, including:

receiving a sharing state display instruction, and controlling the second light source to turn on based on the sharing state display instruction; or,

receiving an anti-peep state display instruction, and controlling the second light source to turn off and controlling the first light source to turn on based on the anti-peep state display instruction.

One or more embodiments of this specification further provide a display apparatus, including a display panel and the backlight module according to any one of the above.

It can be seen from the above that in the backlight module, the driving method thereof and the display apparatus provided in one or more embodiments of this specification, a plurality of recessed portions and raised portions alternately distributed in sequence are formed on a back plate, a first light source is provided inside the recessed portion, and a second light source is provided on the raised portion. In the sharing state, the second light source is controlled to emit light, so as to realize the requirement of sharing at a large viewing angle. In the anti-peep state, the second light source is turned off and only the first light source is controlled to emit light. The light emitted from the first light source will be blocked by the inner wall of the recessed portion and reflected out by the reflective layer, so that the included angle of the emitted light is smaller than the original angle of the light emitted from the first light source, which meets the requirements of the anti-peep state at a small viewing angle. The structure replaces the anti-peep film and PDLC in the prior art, and achieves the effect of reducing the viewing angle, so that the display apparatus manufactured by using the back plate of this embodiment can not only realize the anti-peep state with high uniformity and high collimation, but also realize the sharing state at a large viewing angle, and there is no light absorption loss, the brightness of both the anti-peep state and the sharing state will be increased, which greatly improves the light effect and enhances the visual effect.

### BRIEF DESCRIPTION OF THE DRAWINGS

In order to more clearly explain one or more embodiments of this specification or the technical solutions in the prior art, the following will briefly introduce the accompanying drawings that need to be used in the description of the embodiments or the prior art. The accompanying drawings in the following description are only one or more embodiments of the present specification. For those of ordinary skill in the art, other drawings can be obtained based on these drawings without creative work.

FIG. 1 is a structural diagram of a first-generation anti-peep display apparatus in the prior art;

FIG. 2 is a structural diagram of a second-generation anti-peep display apparatus in the prior art;

FIG. 3 is a schematic diagram of a structure of a backlight module according to one or more embodiments of this specification;

FIG. 4 is a schematic diagram of a display principle of the backlight module in an anti-peep state according to one or more embodiments of this specification;

FIG. 5 is a schematic diagram of a display principle of the backlight module in a sharing state according to one or more embodiments of this specification;

FIG. 6 is a front view of the first structure of the backlight module according to one or more embodiments of this specification;

FIG. 7 is a front view of the second structure of the backlight module according to one or more embodiments of this specification;

FIG. 8 is a schematic diagram of the principle of the anti-peep display of the backlight module according to one or more embodiments of this specification;

FIG. 9 is a schematic diagram of the simulated brightness uniformity of the anti-peep display of the backlight module according to one or more embodiments of the specification;

FIG. 10 is a schematic diagram of a viewing angle simulation result of the backlight module in the anti-peep state according to one or more embodiments of this specification;

FIG. 11 is a schematic diagram of a simulation result of an anti-peep film in an anti-peep state in the prior art;

FIG. 12 is a schematic diagram of the simulated brightness uniformity of the sharing display of the backlight module according to one or more embodiments of this specification;

FIG. 13 is a schematic diagram of a viewing angle simulation result of the backlight module in a sharing state according to one or more embodiments of this specification;

FIG. 14 is a schematic diagram of simulation results of a PDLC in a sharing state in the prior art; and

FIG. 15 is a schematic diagram of the structure of a display apparatus according to one or more embodiments of this specification.

### DETAILED DESCRIPTION

In order to make the objectives, technical solutions, and advantages of the present disclosure more clear, the present disclosure will be further described in detail below in conjunction with specific embodiments and with reference to the accompanying drawings.

It should be noted that, unless otherwise defined, the technical terms or scientific terms used in one or more embodiments of this specification should be the usual meanings understood by those with ordinary skills in the field to which this disclosure belongs. “First”, “second”, and similar words used in one or more embodiments of this specification do not denote any order, quantity or importance, but are only used to distinguish different components. “Include”, “include”, and other similar words mean that the element or item appearing before the word covers the element or item listed after the word and their equivalents, but does not exclude other elements or items. Similar words such as “connected” or “coupled” are not limited to physical or mechanical connections, but may include electrical connections, regardless of direct or indirect connection. “Up”, “down”, “left”, “right”, etc. are only used to indicate the relative position relationship. When the absolute position of the described object changes, the relative position relationship may also change accordingly.

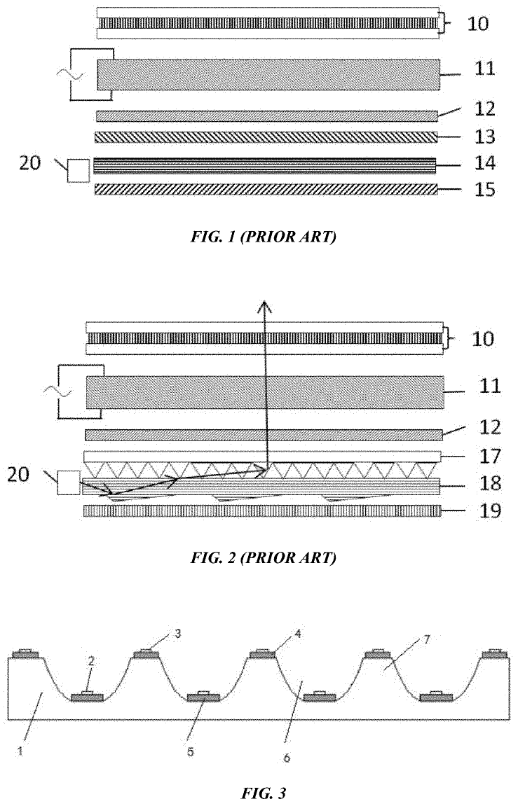

As shown in FIG. 1, it is a structural diagram of the first-generation anti-peep display apparatus in the prior art. In the first-generation anti-peep display apparatus, a layer of 3M anti-peep film (privacy film) 12 and polymer dispersed liquid crystal (PDLC) film 11 is added between the side-type backlight unit (BLU) and the LCD display panel 10. The side-type backlight unit includes an LED light bar 20, a reflective film (ESR) 15, a light guide plate (LGP) 14 and a prism 13. Its disadvantage is that the thickness is large and the brightness loss of the two layer films is large, the center brightness of the LCD module (LCM) in a sharing state (also referred to as a non-anti-peep state) and an anti-peep state is very low, which is only about 120 nit, and the anti-peep viewing angle is increased accordingly.

As shown in FIG. 2, it is a structural diagram of a second-generation anti-peep display apparatus in the prior art. The second-generation anti-peep apparatus removes the traditional upper and lower prisms, the diffuser and light guide plate (LGP), and replaces them with a reverse prism (R-prism) 17 and a light guide film (LGF) 18, and further adds a layer of 3M anti-peep film 12 and PDLC film 11. The advantage is that the thickness is reduced, but the disadvantage is that the brightness in the sharing state is still insufficient, which is only about 200 nits.

Currently, the third-generation anti-peep apparatus is also being developed. Compared with the second generation, the third-generation anti-peep apparatus removes the anti-peep film and replaces it with a collimating film. Its advantage is that the brightness will be improved (the brightness loss of the anti-peep film is 50%-60%), but the scheme process of the collimation system is complicated, and the requirements for processing accuracy are particularly high, and the anti-peep effect at the large viewing angle is still not ideal.

Based on the foregoing reasons, one or more embodiments of this specification provide a backlight module for realizing the anti-peep function of a display apparatus, and the anti-peep display apparatus has high uniformity and high collimation. As shown in FIG. 3, the backlight module includes a back plate 1, reflective layer, a first light source 2 and a second light source 3.

The back plate 1 is provided with a plurality of recessed portions 6 and raised portions 7 alternately distributed in sequence. In some optional embodiments, strip-shaped grooves or reflective cup-shaped recesses are provided on the back plate 1 having a certain thickness, to form a recessed portion 6 on the back plate 1, and a raised portion 7 is formed between two adjacent recessed portions 6.

The reflective layer (not shown in FIG. 3) is provided on an inner wall of the recessed portion 6. In the embodiment, the reflective layer is coated with a high-reflectivity material and can reflect the light irradiated on the reflective layer.

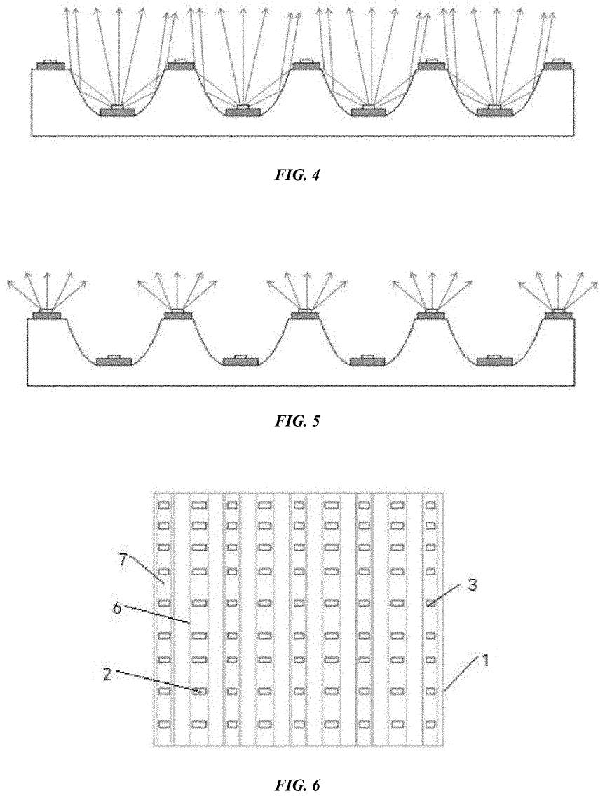

The first light source 2 is provided at a bottom of the recessed portion 6, and the first light source 2 is configured to emit light in an anti-peep state. As shown in FIG. 4, since the first light source 2 is arranged at the bottom of the recessed portion 6, a part of the light emitted from the first light source 2 will be blocked by the inner wall of the recessed portion 6 and reflected out by the reflective layer. The direction of the reflected light changes, so that the included angle of the emitted light is smaller than the original angle of light emitted from the first light source 2, the emitted light has a high degree of collimation, and meets the requirements of the anti-peep state at a small viewing angle. At the same time, due to the existence of the reflective layer, all the lateral light emitted from the first light source 2 is reflected out, which greatly improves the light efficiency compared with the traditional back plate.

The second light source 3 is arranged on the raised portion and configured to not emit light in the anti-peep state and emit light in the sharing state. As shown in FIG. 5, since the second light source 3 is arranged on the raised portion 7, the light emitted from the second light source 3 is not blocked and reflected, the included angle of the emitted light is the original angle of light emitted from the light source, which satisfies the requirements of the sharing state at a large viewing angle.

In this embodiment, a plurality of recessed portions 6 and raised portions 7 alternately distributed in sequence are formed on a back plate 1, a first light source 2 is provided inside the recessed portion 6, and a second light source 3 is provided on the raised portion 7. In the sharing state, the second light source 3 is controlled to emit light, so as to realize the requirement of sharing at a large viewing angle. In the anti-peep state, the second light source 3 is turned off and only the first light source 2 is controlled to emit light. The light emitted from the first light source 2 will be blocked by the inner wall of the recessed portion 6 and reflected out by the reflective layer, so that the included angle of the emitted light is smaller than the original angle of the light emitted from the first light source 2, which meets the requirements of the anti-peep state at a small viewing angle. The structure replaces the anti-peep film and PDLC in the prior art, and achieves the effect of reducing the viewing angle, so that the display apparatus manufactured by using the back plate of this embodiment can not only realize the anti-peep state with high uniformity and high collimation, but also realize the sharing state at a large viewing angle, and there is no light absorption loss, the brightness of both the anti-peep state and the sharing state will be increased, which greatly improves the light effect and enhances the visual effect.

Optionally, in the sharing state, the first light source 2 may be configured to not emit light, or may be configured to emit light. When the first light source 2 is configured to emit light, the light emission brightness in the sharing state can be improved.

Optionally, in the foregoing embodiment, the angles of light emitted from the first light source 2 and the second light source 3 may be the same or different. Optionally, in order to facilitate the selection of the light source elements and improve the efficiency of the installation of the first light source 2 and the second light source 3, the angles of light emitted from the first light source 2 and the second light source 3 are the same.

Optionally, the back plate 1 in this embodiment can be a component that replaces the substrate (FPC/glass) in the conventional surface light source. The first light source 2 and the second light source 3 are glued together with the TFOG (Touch FPC On Glass) tape during processing.

In some optional embodiments of this specification, each of the recessed portions 6 is a groove having an extension direction perpendicular to a direction along which any recessed portion 6 faces toward a raised portion 7 adjacent to the recessed portion 6, and the grooves are equidistantly distributed along the direction that any recessed portion 6 faces toward a raised portion 7 adjacent to the recessed portion 6. As shown in FIG. 6, each of the recessed portions 6 is a strip-shaped groove, and the first light source 2 and the second light source 3 are respectively distributed in an array on the recessed portion 6 and the raised portion 7 of the back plate 1. Such a structural design facilitates the processing of the back plate 1 and the subsequent installation of the first light source 2.

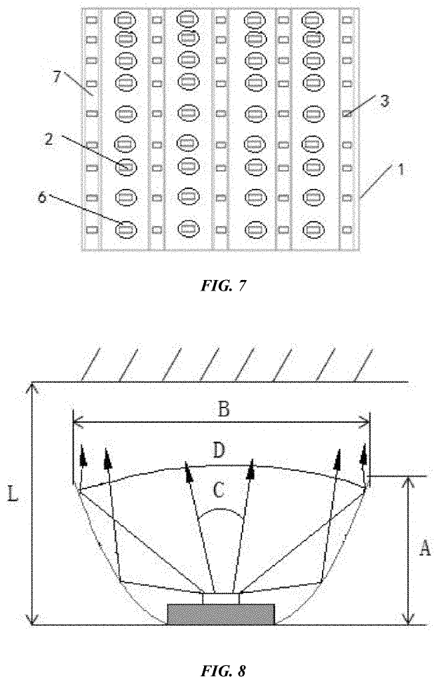

In other optional embodiments, as shown in FIG. 7, each recessed portion 6 has a cup-shaped structure, that is, each recessed portion 6 has a reflective cup structure, and a plurality of recessed portions 6 are arrayed on the back plate 1. At the same time, each first light source 2 is respectively arranged on the bottom of a cup-shaped recessed portion 6 and a reflective layer is provided on the side wall of the recessed portion 6, which can further improve the reflection efficiency of light laterally emitted from the first light source 2, and further improve the light efficiency.

Optionally, as shown in FIG. 3, a size of the bottom of the recessed portion 6 is smaller than that of an opening of the recessed portion 6, thus facilitating the reflection of the lateral light emitted from the first light source 2 and improving the reflection efficiency.

In some optional embodiments of the present specification, the inner wall of the recessed portion 6 includes one of various types such as a flat surface, a curved surface, and a polygonal surface. The angle of light emitted from the first light source 2 is controlled by the shape of the inner wall of the recessed portion 6, so as to meet the requirements of the anti-peep angle. For example, when the inner wall of the recessed portion 6 is a curved surface, the angle of light emitted from the first light source 2 is determined by the curvature of the curved surface. The shape of the recessed portion 6 is determined as long as the curvature of the inner wall of the recessed portion 6 that meets the light efficiency requirements is calculated. Since the shape of the recessed portion 6 is mainly determined by the light source distance between the center of the first light source 2 and the opening of the recessed portion 6 and the diameter at the opening of the recessed portion 6, the brightness uniformity effect of the first light source 2 is determined by the angle of the strongest light, the maximum reflected light angle and the irradiation distance. The maximum reflected light angle is determined by the curvature of the inner wall curved surface of the recessed portion 6. Therefore, the method of confirming the inner wall shape of the recessed portion includes:

as shown in FIG. 8, acquiring a light source distance A between a center of the first light source 2 and an opening of the recessed portion 6, a diameter B at the opening of the recessed portion 6, an angle C of the strongest light, a maximum reflected light angle D, and an irradiation distance L; confirming an overall dimension of the recessed portion 6 and the maximum reflected light angle D based on the light source distance A and the diameter B at the opening; determining a brightness distribution of the first light source 2 based on the angle C of the strongest light, the maximum reflected light angle D and the irradiation distance L; and determining a reflection curve based on the light source distance A, the diameter B at the opening, the angle C of the strongest light and the maximum reflected light angle D, and determining a shape of the inner wall of the recessed portion based on the reflection curve. In this embodiment, according to actual needs, an optical simulation software such as LightTools is used to set the above four parameters A, B, C, D and the light intensity distribution of the first light source 2, the curvature of the inner wall curved surface of the recessed portion 6 can be obtained and then the shape of the inner wall of the recessed portion may be designed by a 3D modeling software.

In some optional embodiments, the reflective layer is formed by coating a highly reflective material. The material of the reflective layer includes one of a specular reflective material (such as silver, aluminum, etc.), a diffuse reflective material (such as white ink, white glue, resin, etc.), and a reflective material with a surface microstructure (such as circular dots, multilayer film systems, Fresnel prism structure, etc.). The use of highly reflective materials further improves the reflection efficiency of the reflective layer and reduces the light loss.

Optionally, each of the first light source 2 and the second light source 3 includes an LED light bar or an LED chip, and the LED light type includes but not limited to Lambertian light emission and any other light types.

Optionally, a plurality of the first light sources 2 are distributed in an array on the back plate 1; and a plurality of the second light sources 3 are distributed in an array on the back plate 1.

Optionally, the backlight module described in the embodiment of this specification further includes: a first circuit board 5, provided between the first light source 2 and the recessed portion 6 to realize a connection between the first light source 2 and the driving circuit; a second circuit board 4, provided between the second light source 3 and the raised portion 7 to realize a connection between the second light source 3 and the driving circuit. In the embodiment, the first circuit board 5 and the second circuit board 4 may be FPC substrates, PCB substrates, glass, or the like.

Optionally, the backlight module described in the embodiment of this specification further includes a diffusion film provided on a side of the second light source 2 away from the back plate 1, i.e., a diffusion film having a specific concentration is provided between the back plate 1 and the display panel. The anti-peep viewing angle may be adjusted to be ±30°, which is the same as the existing 3M anti-peep film, and the light efficiency is significantly improved.

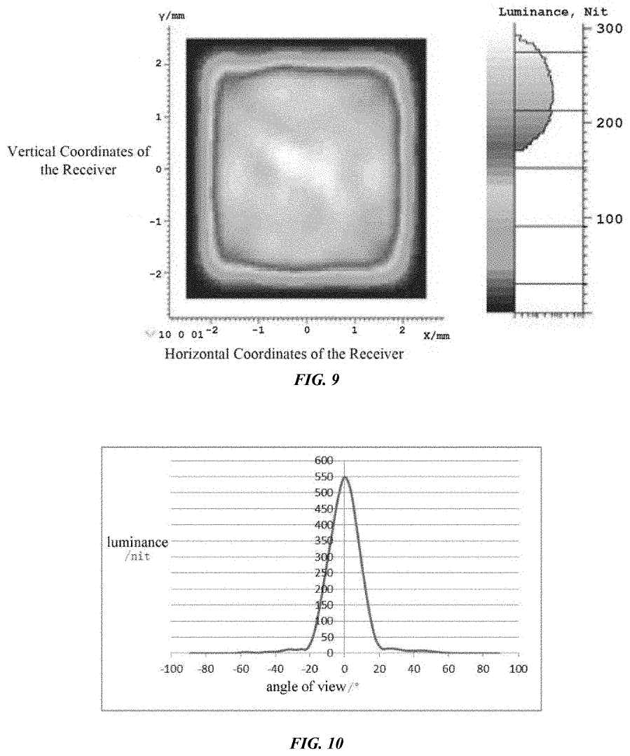

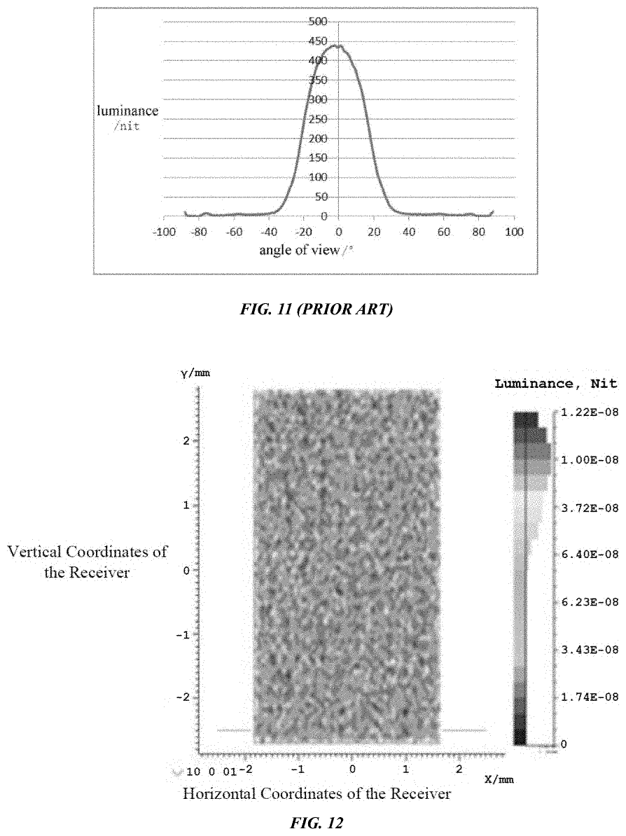

In an optional embodiment of this specification, the depth of the recessed portion 6 is 300 um. In this embodiment, in combination with the light type of the first light source 2, when the first light source 2 is turned on, the light emitted from the first light source 2 is reflected by the reflective layer, and the shape and curvature of the inner wall of the recessed portion 6 can be simulated by the software, and the simulated illumination pattern is shown in FIG. 9. It can be seen that light is uniformly emitted at the opening of the recessed portion 6, and its uniformity is greater than 80%. At the same time, the reflective layer uses all the side light emission of the first light source 2, which greatly improves light efficiency compared with the traditional backlight, light loss (i.e., the reflection loss of the reflective layer) is less than 10%, and the emitted light has a high degree of collimation. The angle of emitted light is shown in FIG. 10, having a Gaussian distribution between about ±20°, which meets the requirements of the anti-peep angle (compared with the anti-peep viewing angle of the anti-peep film in the prior art shown in FIG. 11).

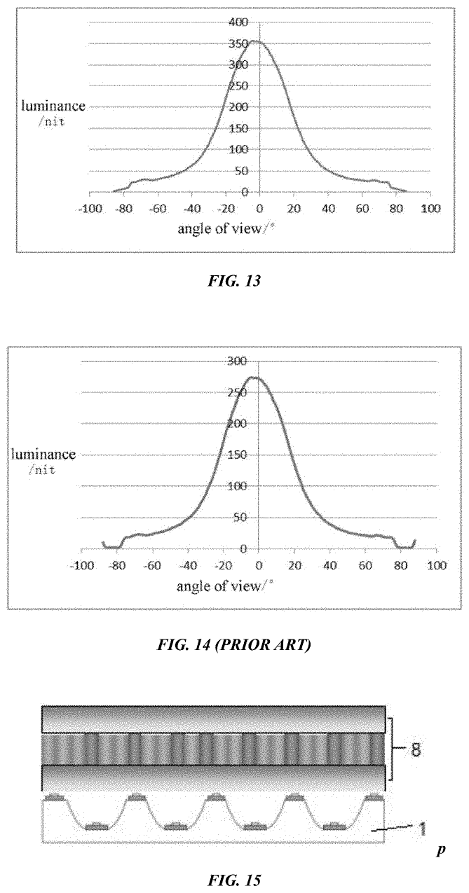

In the sharing state, when only the second light source 3 is turned on or both the first light source 2 and the second light source 3 are turned on at the same time, the corresponding brightness distribution simulation result is shown in FIG. 12. From the simulation result, it can be seen that after the second light source 3 is turned on, a uniform brightness distribution is formed, and the uniformity is also greater than 80%, which meets the requirements of the display module backlight. The corresponding viewing angle distribution is shown in FIG. 13 (compared with the viewing angle in the sharing state of the PDLC in the prior art as shown in FIG. 14), which meets the requirement of the sharing state at a large viewing angle.

Other embodiments of this specification provide a driving method of a backlight module, including: receiving a sharing state display instruction, and controlling the second light source to turn on based on the sharing state display instruction; or, receiving an anti-peep state display instruction, and controlling the second light source to turn off and controlling the first light source to turn on based on the anti-peep state display instruction.

In this embodiment, when a sharing state display instruction is received, the driver IC detects the working state of the second light source 3 and turns on the second light source 3 if the second light source 3 is not turned on, so that the emitted light diverges, and the sharing state display requirement is realized. The first light source 2 can also be controlled to turn on when necessary, to increase the display brightness.

When the anti-peep state display instruction control is received, the driver IC detects the working state of the first light source 2 and the second light source 3, and controls the second light source 3 to turn off and controls the first light source 2 to turn on according to the current working state, so that the emitted light is narrowed to meet the anti-peep state display requirements.

Other embodiments of this specification further provide a display apparatus. As shown in FIG. 15, the display apparatus includes a display panel 8 and the backlight module according to any one of the above embodiments. The display panel 8 may be a liquid crystal display (LCD). The display apparatus of this embodiment does not need to be equipped with various laminated structures of conventional backlight sources, such as reflective sheets, LGPs, diffusion sheets, prism sheets, etc., and the backlight module can be directly matched with the display panel 8, which can greatly reduce the thickness of the display apparatus. At the same time, the difficulty of the module process is simplified. The display apparatus described in this embodiment can be used for products of different sizes and types, such as Mobile, TPC, NB, TV, and so on.

Those of ordinary skill in the art should understand that the discussion of any of the above embodiments is only exemplary, and is not intended to imply that the scope of the present disclosure (including the claims) is limited to these examples. Under the idea of the present disclosure, the above embodiments or the technical features in different embodiments can also be combined, the steps can be implemented in any order. There are many other changes in different aspects of one or more embodiments of this specification as described above, and they are not included in the details for the sake of brevity.

In addition, in order to simplify the description and discussion, and in order not to make one or more embodiments of this specification difficult to understand, the accompanying drawings may or may not show well-known power supply/ground connection in relation to integrated circuit (IC) chips and other components. In addition, the apparatus may be shown in the form of a block diagram, in order to avoid making one or more embodiments of this specification difficult to understand, and this also takes into account the fact that the details about the implementation of these block diagram apparatuses highly depends on the platform that will implement one or more embodiments of the present description (that is, these details should be fully within the understanding of those skilled in the art). In the case where specific details (for example, circuits) are illustrated to describe exemplary embodiments of the present disclosure, it is apparent to those skilled in the art that one or more embodiments of this specification may be implemented without these specific details or when these specific details are changed. Therefore, these descriptions should be considered illustrative rather than restrictive.

Although the present disclosure has been described in conjunction with specific embodiments of the present disclosure, based on the foregoing description, many substitutions, modifications, and variations of these embodiments will be apparent to those of ordinary skill in the art. For example, other memory architectures (e.g., dynamic RAM (DRAM)) can use the discussed embodiments.

One or more embodiments of this specification are intended to cover all such substitutions, modifications and variations that fall within the broad scope of the appended claims. Therefore, any omission, modification, equivalent replacement, improvement, etc. made within the spirit and principle of one or more embodiments of the present specification shall be included in the protection scope of the present disclosure.

What is claimed is:

1. A backlight module, comprising:
a back plate provided with a plurality of recessed portions and raised portions alternately distributed in sequence;
a reflective layer provided on an inner wall of the recessed portion and configured to emit light in an anti-peep state;
a first light source provided at a bottom of the recessed portion and configured to emit light in a non-anti-peep state and not emit light in the anti-peep state; and
a second light source provided on the raised portion.

2. The backlight module according to claim 1, wherein each of the recessed portions is a strip-shaped groove, and the strip-shaped grooves are equidistantly distributed on the back plate.

3. The backlight module according to claim 1, wherein each of the recessed portions has a cup-shaped structure, and a plurality of the recessed portions are arranged in an array on the back plate.

4. The backlight module according to claim 2, wherein a size of the bottom of the recessed portion is smaller than that of an opening of the recessed portion.

5. The backlight module according to claim 1, wherein the inner wall of the recessed portion comprises one of a flat surface, a curved surface, and a polygonal surface.

6. The backlight module according to claim 1, wherein a material of the reflective layer comprises one of a specular reflective material, a diffuse reflective material, and a reflective material with a surface microstructure.

7. The backlight module according to claim 1, wherein each of the first light source and the second light source comprises a light-emitting diode (LED) light bar or an LED chip.

8. The backlight module according to claim 1, wherein a plurality of the first light sources are distributed in an array on the back plate; and a plurality of the second light sources are distributed in an array on the back plate.

9. The backlight module according to claim 1, wherein the first light source is further configured to emit light in the non-anti-peep state.

10. The backlight module according to claim 1, further comprising:
a first circuit board provided between the first light source and the recessed portion to realize a connection between the first light source and the driving circuit;
a second circuit board provided between the second light source and the raised portion to realize a connection between the second light source and the driving circuit.

11. The backlight module according to claim 1, further comprising: a diffusion film provided on a side of the second light source away from the back plate.

12. A driving method of a backlight module, comprising:
providing the backlight module, wherein the backlight module comprises: a back plate provided with a plurality of recessed portions and raised portions alternately distributed in sequence; a reflective layer provided on an inner wall of the recessed portion and configured to emit light in an anti-peep state; a first light source provided at a bottom of the recessed portion and configured to emit light in a non-anti-peep state and not emit light in the anti-peep state; and a second light source provided on the raised portion; and
receiving a non-anti-peep state display instruction, and controlling the second light source to turn on based on the non-anti-peep state display instruction; or,
receiving an anti-peep state display instruction, and controlling the second light source to turn off and controlling the first light source to turn on based on the anti-peep state display instruction.

13. A display apparatus, comprising a display panel and a backlight module, wherein the backlight module comprises:
a back plate provided with a plurality of recessed portions and raised portions alternately distributed in sequence;
a reflective layer provided on an inner wall of the recessed portion and configured to emit light in an anti-peep state;
a first light source provided at a bottom of the recessed portion and configured to emit light in a non-anti-peep state and not emit light in the anti-peep state; and
a second light source provided on the raised portion.

14. The display apparatus according to claim 13, wherein each of the recessed portions is a strip-shaped groove, and the strip-shaped grooves are equidistantly distributed on the back plate.

15. The display apparatus according to claim 13, wherein each of the recessed portions has a cup-shaped structure, and a plurality of the recessed portions are arranged in an array on the back plate.

16. The display apparatus according to claim 14, wherein a size of the bottom of the recessed portion is smaller than that of an opening of the recessed portion.

17. The display apparatus according to claim 13, wherein the inner wall of the recessed portion comprises one of a flat surface, a curved surface, and a polygonal surface.

18. The display apparatus according to claim 13, wherein a material of the reflective layer comprises one of a specular reflective material, a diffuse reflective material, and a reflective material with a surface microstructure.

19. The display apparatus according to claim 13, wherein each of the first light source and the second light source comprises an LED light bar or an LED chip.

20. The display apparatus according to claim 13, wherein a plurality of the first light sources are distributed in an array on the back plate; and a plurality of the second light sources are distributed in an array on the back plate.
